(19) United States
(12) Patent Application Publication
(10) Pub. No.: US 2007/0020408 A1
(43) Pub. Date: Jan. 25, 2007

(54) Process for preparing metal compounds of an azo compound using a multistage heat-treatment process

(75) Inventors: Ulrich Feldhues, Bergisch Gladbach (DE); Frank Linke, Koln (DE); Ronald Gobel, Leverkusen (DE); Sabine Endert, Wuppertal (DE); Dirk Pfuetzenreuter, Burscheid (DE)

Correspondence Address: LANXESS CORPORATION, 111 RIDC PARK WEST DRIVE, PITTSBURGH, PA, 15275-1112, US

(73) Assignee: LANXESS Deutschland GmbH

(21) Appl. No.: 11/486,576

(22) Filed: Jul. 14, 2006

(30) Foreign Application Priority Data
Jul. 19, 2005 (DE) 10 2005 033 583.7

(51) Int. Cl. C07F 15/02; C08K 5/34; C09K 19/00

(52) U.S. Cl. 428/1.31; 534/703; 524/90

(57) ABSTRACT

Process for preparing metal compounds of an azo compound which conforms in the form of its tautomeric structures to the formula (I) 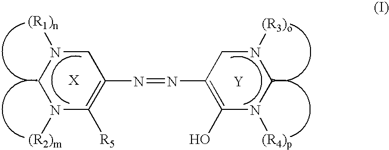 characterized in that an aqueous suspension of a corresponding metal compound is heat-treated in at least two pH stages.

This application claims the benefit of German Application No. 10200503583.7 filed Jul. 19, 2005.

The invention relates to a process for preparing metal compounds of an azo compound using a multistage heat-treatment process, to the use of the metal compounds as pigments, and to the use of the pigments.

Metal complex pigments of metals with an azo compound of the following formula

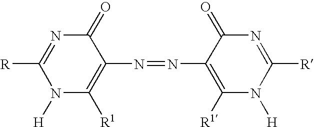

in which

R and R′ independently of one another are OH, NH₂, NH—CN, arylamino or acylamino and

R¹ and R^{1′} independently of one another are —OH or —NH₂,

and also host-guest compounds thereof, are extensively described in the literature, examples being:
DE-A-2 064 093
U.S. Pat. No. 4,622,391
EP 0994 162 A1
EP 0 994 163 A1
EP 0 994 164 A1
DE 103 28 999 A1.

It is also known that preparation can place by heat treatment, the heat treatment taking place advantageously at pigment concentrations of more than 6%. It is known, furthermore, that the heat treatment may take place with the addition of fixed amounts of acids. The pigments prepared by these methods, however, still have disadvantages, particularly in respect of their colour strength.

It was therefore an object of the present invention to provide a cost-effective and readily industrially reproducible process that no longer has the disadvantages described above.

The invention relates to a process for preparing metal compounds of an azo compound of the formula (I)

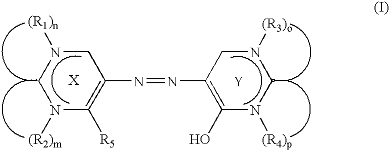

or tautomeric structures thereof,

in which

rings labelled X and Y may each carry one or two substituents from the series ═O, ═S, ═NR₇, —NR₆R₇, —OR₆, —SR₆, —COOR₆, —CN, —CONR₆R₇, —SO₂R₈,

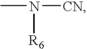

alkyl, cycloalkyl, aryl and aralkyl,

the sum of the endocyclic and exocyclic double bonds for each of rings X and Y being three,
in which
R₆ is hydrogen, alkyl, cycloalkyl, aryl or aralkyl,
R₇ is hydrogen, cyano, alkyl, cycloalkyl, aryl, aralkyl or acyl, and
R₈ is alkyl, cycloalkyl, aryl or aralkyl,

R₁, R₂, R₃ and R₄ are hydrogen, alkyl, cycloalkyl, aryl or aralkyl and additionally, as indicated in formula (I) by the interrupted lines, may form 5- or 6-membered rings, to which further rings may be fused,

R₅ is —OH, —NR₆R₇, alkyl, cycloalkyl, aryl or aralkyl, in which R₆ and R₇ are as defined above,

and in the substituents given for R₁ to R₈ that contain CH groups the hydrogen atoms in the CH groups may be substituted,

and m, n, o and p may be 1 (one) or alternatively, where double bonds start from the ring nitrogen atoms on which the corresponding substituents R₁ to R₄ are located, as indicated in formula (I) by the dotted lines, may be 0 (zero),

and which optionally contain a guest compound,

characterized in that the metal compound or a host-guest compound thereof is heat treated in at least two pH stages.

In particular the process of the invention is characterized in that an aqueous suspension of the metal compound is prepared by reacting an azo compound of the formula (I) with a metal salt and optionally with an intended guest compound in water and optionally organic solvent and the suspension prepared is heat treated in at least two pH stages.

The term “heat treatment” or “heat treating” denotes preferably, in accordance with the invention, the maintenance of a suspension or dispersion of the metal compound and/or the host-guest compound thereof in a preferably aqueous medium at a defined temperature and a defined pH. The temperature is preferably substantially constant within each heat-treatment stage. Thus in one heat-treatment stage the temperature fluctuates preferably by not more than ±5° C., preferably by not more than ±3° around a central figure. However, it is also possible for the heat-treatment temperature to fluctuate or be altered in each heat-treatment stage. It is critical here that heat treatment takes place at least two different pH stages. In the heat-treatment or pH stages it is preferred to set a defined pH of the aqueous suspension. Within each heat-treatment stage, preferably, the pH is substantially constant. In one heat-treatment or pH stage it fluctuates preferably by not more than ±1 pH unit, more preferably by not more than ±0.5 pH unit.

For the skilled person it is completely surprising that by heat-treating the metal compound or host-guest compound in at least two pH stages, as compared with single-stage heat treatment, it is possible to obtain significantly improved product properties, particularly colour strength, and/or manufacturing costs.

Preferably the multistage heat treatment is carried out preferably in a dispersion with a solids contents of more than 3% by weight, more preferably in a dispersion having a solids content between 4%-15% by weight, very preferably between 6%-10% by weight.

Advantageously the multistage heat treatment takes place in each heat-treatment stage at temperatures between 80 to 125° C. Preferably the multistage heat treatment is carried out in each heat-treatment stage at temperatures between 90° C. and 120° C., in particular between 95° C. and 110° C. The invention also embraces the case where the temperature is substantially the same in each heat-treatment stage. That is, heat treatment is carried out at substantially the same temperature but at different pH levels. In two heat-treatment stages, for example, the temperature can be lower or higher in the first heat-treatment stage than in the second heat-treatment stage.

The multistage heat treatment carried out in accordance with the invention is preferably carried out in water and optionally organic solvents of pH levels in the range from 0 to 4.

The pH of at least one heat-treatment stage is preferably between 2 and 4, in particular between 2.5 and 3.5. The pH of the second heat-treatment stage is preferably between 0 and 3, more preferably between 1 and 2.5. The pH levels of two heat-treatment stages preferably differ by 0.5 to 3 units, preferably by 1 to 2 units. The second of at least two heat-treatment stages is preferably carried out at a lower pH than the first heat-treatment stage.

At least two heat-treatment stages preferably last, independently of one another, between 0.25 h and 24 h, in particular between 1 h and 12 h, very preferably between 2 h and 8 h.

The first heat-treatment stage preferably takes place at a higher pH than the second or further heat-treatment stage(s). The duration of the first heat-treatment stage is preferably shorter up to a maximum of equal length as compared with the second or further heat-treatment stage(s).

Without being tied to one theory it is assumed that in the first heat-treatment stage, which is preferably carried out at higher pH levels than the second or further heat-treatment stage, there is a deaggregation of the metal compounds and/or the host-guest compounds, whereas in the subsequent stage there is crystal growth of the metal compounds and/or host-guest compounds.

In the first heat-treatment stage of the process of the invention it is preferred to set—by adding acid—a pH in particular in the range from 2.5 to 3.5. In the second or following heat-treatment stage, which may also optionally follow directly the first heat-treatment stage (especially when the second heat-treatment stage takes place at substantially the same temperature), a reduction in pH is achieved preferably by the addition of a fixed amount of acid. The metal compounds and host-guest compounds thereof that are prepared by the process of the invention are preferably very substantially deaggregated or deagglomerated and possess a narrow particle size distribution, which in particular is narrower than the particle size distribution of the metal compounds and/or host-guest compounds thereof prior to the heat treatment of the invention.

In accordance with the invention, metal compounds of an azo compound of the formula (I) are understood in particular to be metal complex compounds of the azo compound of the formula (I) and/or saltlike metal compounds of the azo compound of the formula (I). In the metal compounds prepared in accordance with the invention, the azo compound of the formula (I) is generally present with single or multiple deprotonation as an anion, whereas the metals are present as cations, which are joined in saltlike to complexlike fashion or coordinatively (that is, with covalent bonding components) to the anion of the azo compound of the formula (I). Formula (I) shows the azo compound in the non-deprotonated form, i.e. in the free acid form. The preparation of these complexlike and/or saltlike metal compounds is based preferably on the reaction of the acidic azo compounds of the formula (I) with metal compounds, optionally in the presence of bases, to form the metal compounds of an azo compound of the formula (I).

The metal compounds prepared in accordance with the invention, or the host-guest compounds thereof, can also be in the form of hydrates.

The abovementioned number of substituents on the rings labelled X and Y (one or two substituents) is to be understood in accordance with the invention not to include the drawn-in substituents R₁ to R₅ and —OH. The stated substituents on the rings labelled X and Y are therefore the substituents which are located on the positions not occupied by R₁ to R₅. With the substituents R₁ to R₅, therefore, it is also possible for more than two substituents to be located on the rings labelled X and Y.

In one preferred embodiment of the process of the invention in the compound of the formula (I) the ring labelled X is a ring of the formula

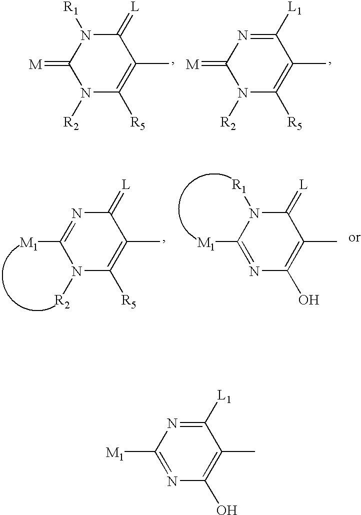

in which

L and M independently of one another are ═O, ═S or ═NR₆,

L₁ is hydrogen, —OR₆, —SR₆, —NR₆R₇, —COOR₆, —CONR₆R₇, —CN, alkyl, cycloalkyl, aryl or aralkyl, and

M₁ is —OR₆, —SR₆, —NR₆R₇, —COOR₆, —CONR₆R₇, —CN, —SO₂R₈, 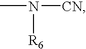
alkyl, cycloalkyl, aryl or aralkyl,

or the substituents M₁ and R₁ or M₁ and R₂ may form a 5- or 6-membered ring, and

R₁, R₂, R₅, R₆, R₇ and R₈ are as defined above.

Particularly preferred metal compounds prepared in accordance with the invention are those of azo compounds which conform in the form of their free acids to structures of the formulae (II) or (III)

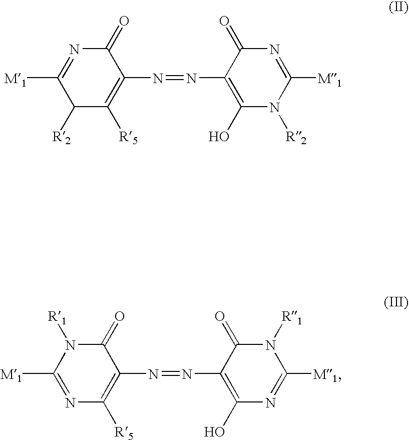

or to a form tautomeric therewith,

in which

R′₅ is —OH or —NH₂,

R′₁, R″₁, R′₂ and R″₂ are each hydrogen, and

M′₁ and M″₁ independently of one another are hydrogen, —OH, —NH₂, —NHCN, arylamino or acylamino.

Especially preferred metal compounds are those of azo compounds of the formula (I) which conform in the form of their free acid to a structure of the formula (IV)

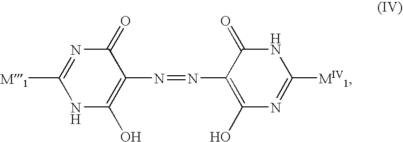

or tautomeric structures thereof,

in which

M′″₁ and M^{IV}₁ independently of one another are OH and/or NHCN.

Particular preference is given to metal compounds of azo compounds of the formula:

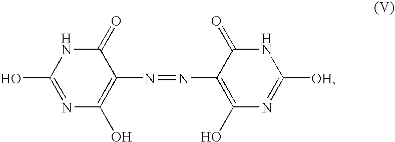

or structures tautomeric therewith.

In the above formulae the substituents preferably have the following definitions:

Substituents in the definition of alkyl are preferably C₁-C₆ alkyl, which may be substituted for example by halogen, such as chlorine, bromine or fluorine, —OH, —CN, —NH₂ or C₁-C₆ alkoxy. C₁-C₆ Alkyl therein is straight-chain or branched alkyl having 1 to 6 carbon atoms, such as methyl, ethyl, propyl, butyl, pentyl or hexyl, including all isomeric forms thereof.

Substituents in the definition of cycloalkyl are preferably C₃-C₇ cycloalkyl, especially C₅-C₆ cycloalkyl, which may be substituted for example by C₁-C₆ alkyl, C₁-C₆ alkoxy, halogen such as Cl, Br, F, C₁-C₆ alkoxy, —OH, —CN and NH₂.

Substituents in the definition of aryl are preferably phenyl or naphthyl, which may be substituted for example by halogen such as F, Cl, Br, —OH, C₁-C₆ alkyl, C₁-C₆ alkoxy, —NH₂, —NO₂ and —CN.

Substituents in the definition of aralkyl are preferably phenyl- or naphthyl-C₁-C₄ alkyl, which may be substituted in the aromatic radicals by for example halogen such as F, Cl, Br, —OH, C₁-C₆ alkyl, C₁-C₆ alkoxy, —NH₂, —NO₂ and —CN.

Substituents in the definition of acyl are preferably (C₁-C₆ alkyl)-carbonyl, phenylcarbonyl, C₁-C₆ alkylsulphonyl, phenylsulphonyl, optionally C₁-C₆ alkyl-, phenyl- and naphthyl-substituted carbamoyl, optionally C₁-C₆ alkyl-, phenyl- and naphthyl-substituted sulphamoyl or optionally C₁-C₆ alkyl-, phenyl- or naphthyl-substituted guanyl, the stated alkyl radicals being able to be substituted for example by halogen such as Cl, Br, F, —OH, —CN, —NH₂ or C₁-C₆ alkoxy, and the stated phenyl and naphthyl radicals being able to be substituted by for example halogen such as F, Cl, Br, —OH, C₁-C₆ alkyl, C₁-C₆ alkoxy, —NH₂, —NO₂ and —CN.

Where M₁ together with R₁ or M₁ together with R₂ and/or R₁, R₂, R₃ and/or R₄, as indicated in the formulae above by means of the interrupted lines, form 5- or 6-membered rings, the ring systems in question are preferably triazole, imidazole or benzimidazole, pyrimidine or quinazoline ring systems.

As metal compounds—by which, as already described, are meant saltlike or complexlike metal compounds—of the azo compounds of the formulae (I) to (V), suitable representatives are preferably the salts and complexes of the mono-,-di-, tri- and tetraanions of the azo compounds of the formulae (I) to (V). Suitable metals are selected advantageously from one or more metals selected from the group consisting of Li, Na, K, Mg, Ca, Sr, Ba, Al, Sn, Pb, Sc, Ti, V, Cr, Mn, Fe, Co, Ni, Cu, Zn, Y, Zr, Nb, Mo, Cd, Hf, Ta, W, La, Ce, Pr and Nd. Nickel is preferred.

Particular preference is given to salts and complexes of formulae (I) to (V) with divalent or trivalent metals, especially the nickel salts and nickel complexes. In one preferred embodiment of the processes of the invention an Ni salt or an Ni complex of the azo compound of the formula (I) is prepared.

The metal compound is preferably the 1:1 azobarbituric acid-nickel complex of the structure

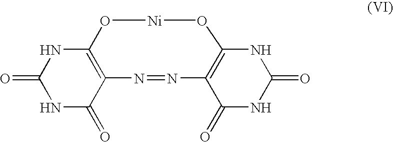

or a structure tautomeric therewith.

The metal compounds prepared in accordance with the invention may optionally contain one or more guest compounds. The guest compound is preferably an inorganic compound, i.e. a compound having at least one covalently bonded carbon atom. The compositions of metal compound and guest organic compound that are prepared in accordance with the invention may be inclusions compounds, intercalation compounds or solid solutions.

With preference they are inclusion compounds, intercalation compounds or solid solutions of a 1:1 azobarbituric acid-nickel complex of the structure

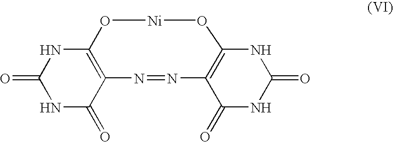

or of a structure tautomeric therewith and of at least one other organic compound included therein.

With particular preference they are intercalation compounds of the above-described metal compound of the formula (VI) with melamine in a molar ratio of 1:2.

Generally speaking, the metal compounds prepared in accordance with the invention form laminar crystal lattices in which the bonding within one la mnina is essentially by way of hydrogen bonds and/or metal ions. The metal complexes in question preferably form a crystal lattice composed of substantially planar laminae.

The inventive preparation of the metal complexes of the azo compound of the formula (I) or of the host-guest compounds thereof takes place preferably in the presence of seed crystals which preferably possess the same chemical structure as the metal compounds of the azo compound of the formula (I) or host-guest compounds thereof that are to be prepared by the process of the invention. In particular, when the product to be prepared is a composition of a metal compound of the azo compound of the formula (I) and a compound present as a guest therein, use is made also of seed crystals of an inclusion composition of this kind. The use of seed crystals in the preparation of the metal compounds or host-guest compounds thereof leads in general to higher BET specific surface areas. Although the multistage heat treatment carried out in accordance with the invention generally leads to a reduction in the BET specific surface areas, it may equally well be advantageous in the context of the invention to carry out the preparation of the metal compounds or host-guest compounds thereof in the presence of seed crystals. On the one hand, the use of seed crystals leads to an improvement in the reproducibility of the preparation, particularly in the case of the batch process, as is preferably employed here. On the other hand, however, it may also be sensible to start from as high as possible a level of specific surface area on the part of the metal compounds or host-guest compounds prior to the heat treatment. It has surprisingly emerged that the physical properties of the seed crystals used do not necessarily determine the physical properties of the metal compounds to be prepared. Thus, for example, metal compounds having a high BET specific surface area are obtained even when the seed crystals employed have a comparatively low BET specific surface area. The preparation takes place preferably in the presence of 1 ppm-10 000 ppm of seed crystals, based on the theoretically obtainable amount of the metal compound to be prepared in a given reaction batch, in particular of 10 ppm-5000 ppm, very preferably of 50 ppm-3000 ppm, in particular of 100 ppm-2000 ppm. In one particularly preferred process of the invention seed crystals are introduced into the reactor or left therein by leaving behind the desired amount of product from a precursor batch. Leaving behind the desired amount of product may be employed with economic advantage particularly in the case of serial production operations.

Depending on the starting material used in the heat-treatment stages, it is possible thus by the process of the invention to obtain BET specific surface areas of the metal compounds of the azo compounds of the formula (I) or of the composition with at least one guest compound thereof from 60 to 180 m²/g, in particular from 70 to 160 m²/g, preferably from 80 to 140 m²/g and in particular from 90 to 120 m²/g. The specific surface area is determined in accordance with DIN 66131: Determination of specific surface area of solids by gas adsorption by the method of Brunauer, Emmett and Teller (B.E.T.).

The process of the invention is preferably carried out batchwise, i.e., as what is called a batch process. The term “batch process”, as the skilled person is well aware, means a discontinuous process. That is, the preparation of the metal compounds is carried out not continuously but instead in batches, or batchwise. After one reaction batch has been completed, the product is isolated. In the case of the continuous process, in contrast, starting materials are continuously supplied and product continuously removed.

In the context of this specification the metal compounds of the azo compounds of the formula (I), which preferably contain at least one guest compound, are also referred to as inventively prepared pigments.

Suitable metal compounds include those in which a metallic compound, such as a salt or a metal complex, has been incorporated into the crystal lattice of another metal complex, such as the nickel complex, for example. In this case it is possible for some of the metal, such as of the nickel, in formula (VI), for example, to be replaced by other metal ions, or further metal ions may enter into a more or less strong interaction with the metal compound, preferably a nickel complex.

Inclusion compounds, intercalation compounds and solid solutions of the metal complexes per se are known from the literature. They are also described, and their preparation, in EP 0 074 515, EP 0 073 463, EP 0994163 and EP 0994162 (page 5, line 40 to page 7, line 58 therein), for example. Reference may thus be made to the entire content of the recitation of suitable compounds in those publications.

Particularly preferred guest compounds used are melamine or melamine derivatives, particularly those of the formula (VII)

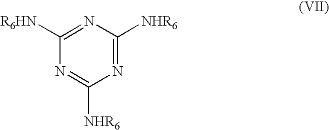

in which

R₆ is hydrogen or C₁-C₄ alkyl, which is optionally substituted by OH groups,

and very preferably those in which

R₆ is hydrogen.

The amount of guest substance which can be incorporated into the crystal lattice of the metal complex is generally 5% to 200% by weight, based on the amount of metal compound. It is preferred to incorporate 10% to 100% by weight. This is the amount of guest substance which cannot be removed by washing with appropriate solvents, and which is apparent from elemental analysis. It is of course also possible to add more or less than the stated amount of substance, and an optional possibility is to not wash out any excess. Preference is given to amounts from 10% to 150% by weight, based on the amount of metal compound.

The preparation of the metal compounds or of the host-guest compounds thereof takes place for example as described in EP 0 074 515, EP 0 073 463, EP 0994163 and EP 0994162. Following the synthesis of the azo compound, complexing is carried out with a metal salt, generally in the presence of the compound to be intercalated. In the case of intercalation compounds of complexes of divalent and trivalent metals that are of industrial interest, particularly of the technically and economically important intercalation compound of the azobarbituric acid-nickel complex, complexing and intercalation, and also the subsequent isolation, take place advantageously in the acidic pH range.

Metal salt suitability is possessed preferably by water-soluble salts of the abovementioned metals, especially chlorides, bromides, acetate, nitrates, etc., preferably of nickel. Metal salts employed with preference possess a water solubility of more than 20 g/l, in particular more than 50 g/l at 20° C.

It is also possible to use mixtures of these salts comprising various of the stated metals. The use of such salt mixtures is advisable in particular for the obtainment of intermediate hues of the coloured end products.

In one preferred embodiment the process of the invention is carried out as a batch process in a reactor, such as in a stirred tank reactor, preferably with application of pumped circulation. “Pumped circulation” here denotes that means are provided with which contents can be removed from the reactor during the preparation and passed back to it again. A preferred embodiment of such pumped circulation involves the reactor used, in particular a stirred tank, having a pipeline system which is preferably situated outside the reactor. The pipeline system is connected to the reactor or reactor contents at at least two different points. The pipeline system includes means with which reactor contents can be taken from the reactor at one or more points and, after passing through the pipeline system, can be passed back again at one or more other points. Particular means of this kind are pumps. The pump circulation system used in accordance with the invention preferably features metering devices which allow reaction partners, examples of which are starting materials, solutions of starting materials, acids, bases, etc., to be introduced into the pipeline system situated outside the reactor.

One particularly preferred process of the invention comprises metering acids and bases not directly into the reactor but instead into the pumped circulation system. A particularly preferred process of the invention comprises metering reactants, acids and/or alkalis or bases in such a way that the metering time is 0.2 times-5 times that of a theoretical total pumped circulation cycle, in particular 1 times-2 times. The theoretical total pumped circulation cycle denotes the period of time within which the volume of the reactor contents has passed once through the pumped circulation system.

It is assumed that the pumped circulation creates a region which exhibits a comparatively high flow velocity. This flow velocity is generally higher than the flow velocity in the stirred tank reactor at points of low stirring effect, such as in the region above the topmost stirring blade, for example. In the case of metered addition in the region of the pumped circulation system it is possible in particular, by virtue of the high flow velocity which prevails there, to avoid local peaks in concentration. Furthermore, better commixing of the reactor contents overall is ensured. The process of the invention produces, surprisingly, a product which has an even higher specific surface area than a product prepared without pumped circulation methods. Moreover, the use of pumped circulation leads to an additional reduction in the fluctuations in product quality. Two or more pumped circulation systems can be employed in parallel.

Pigments used with particular preference in the process of the invention are those which are obtained directly by reaction of azo compounds of the formula (I) with metal salts, preferably those having a water solubility of more than 20, in particular more than 50, g/l at 20° C., and subsequently by reaction with the compound that is to be intercalated.

The un-heat-treated pigments, called reactants below, are preferably obtained as follows in such a way that the reaction with the metal compound takes place at a pH≦2. The subsequent intercalation takes place preferably at a pH from 1 to 7. Where the intercalation is carried out at a pH 4, it is preferred subsequently to raise the pH to more than 4.5, preferably 4.5 to 7.

To adjust the pH it is preferred to use organic or inorganic acids and bases.

Preferred acids are HCl, H₃PO₄, H₂SO₄, HI, HBr, acetic acid and/or formic acid.

Preferred bases used are LiOH, KOH, NaOH, Ca(OH)₂, NH₃, ethanola mine, diethanolamine, triethanolamine and/or dimethylethanolarnine.

This reactant suspension can then, on the one hand, be filtered and the remaining reactant can be washed preferably with water, especially hot water, in order to separate out portions which have not been intercalated, salts, and other impurities.

The reactant thus obtained can be isolated and optionally dried.

Preferably, however, metal compounds obtained directly from the synthesis in a one-pot process, or host-guest compounds, are subjected without isolation to the multistage heat treatment, preferably in at least two pH stages of pH levels between 0 to 4 and temperatures from 80 to 125° C., preferably in a one-pot process. (Temperatures of more than 100° C. imply, in aqueous media, as the skilled person is aware, that the prevailing pressures are above atmospheric pressure.)

The suspension heat-treated by the process of the invention and comprising the pigment of the invention is preferably adjusted to a pH of 4.5 to 7 again after the heat treatment. After that it is preferably filtered. The presscake thus obtained can be dried, optionally after washing with water.

Suitable drying methods in this context include customary methods such as paddle drying, etc. Drying methods of this kind, and subsequent, conventional grinding of the pigment, produce pigments in powder form.

The presscake is preferably spray-dried in the form of an aqueous slurry. With particular preference this takes place by spraying of a slurry containing ammonia in order to increase the solids fraction. The slurry for spraying has a solids fraction preferably of 10% to 40% by weight, in particular 15% to 30% by weight.

A further possibility is to add viscosity-reducing additives to the slurry, such as carboxylic acid and sulphonic acid amides, in an amount of up to 10% by weight, based on the slurry.

The invention further provides a process for preparing pigment formulations, in which at least one inventively prepared metal compound or host-guest compound thereof and at least one dispersant are mixed. These pigment formulations serve preferably for incorporation into aqueous systems.

In respect of suitable dispersants reference may be made to the prior art mentioned at the outset, in particular EP-A1-0994164, page 9, line 56 to page 11, line 23, whose disclosure content is part of this specification. With particular preference the pigment formulation contains more than 90%, in particular more than 95%, preferably more than 97% by weight of pigment (inventively prepared metal compound+optionally compound(s) as guest(s) variant) and dispersant.

The pigments prepared by the multistage heat-treatment process of the invention surprisingly have advantageous properties. The pigments exhibit advantageous colour strength, brilliance, uniformity, dispersibility and/or economic preparability.

The inventively prepared metal compounds or host-guest compounds thereof, or pigment formulations, are outstandingly suitable, moreover, for all pigment end-use applications.

They are suitable, for example, for pigmenting varnishes of all kinds for producing printing inks, distempers or binder covers, for the mass colouring of synthetic, semisynthetic or natural macromolecular substances, such as polyvinyl chloride, polystyrene, polyamide, polyethylene or polypropylene, for example. They can also be used for the spin dyeing of natural, regenerated or artificial fibres, such as cellulose, polyester, polycarbonate, polyacrylonitrile or polyamide fibres, and also for printing textiles and paper. From these pigments it is possible to produce fine, stable, aqueous pigmentations of paints, including emulsion paints, which can be used for colouring paper, for the pigment printing of textiles, for laminate printing or for the spin dyeing of viscose, by grinding or kneading in the presence of nonionic, anionic or cationic surfactants. The pigments prepared by the process of the invention are outstandingly suitable for ink-jet applications and, on the basis of their comparatively high BET specific surface area, for colour filters for liquid-crystal displays.

### EXAMPLES

### Preparation Example 1

190 g of water-moist paste of diazobarbituric acid with a dry-matter content of 81%, corresponding to 154 g dry, are stirred in 3000 g of water using a laboratory stirrer. The mixture is then heated indirectly to 80° C., and at this temperature 134 g of barbituric acid are introduced. After about 30 minutes of subsequent stirring the pH is adjusted to 5.0 using 30% strength potassium hydroxide solution. This is followed by stirring at 80° C. and a pH of 5.0 for 2 hours. The batch is subsequently diluted with water to 5400 g. Subsequently it is heated indirectly to 90° C. and at this temperature 252 g of melamine are introduced. Thereafter 575 g of 22.5% strength nickel chloride solution are added dropwise. 90 minutes of stirring follow, in order to achieve as complete a reaction as possible. The pH is then adjusted to 5.0 using 30% strength potassium hydroxide solution. Thereafter the un-heat-treated suspension is isolated on a suction filter, washed free of electrolyte, dried in a vacuum drying oven at 80° C. and ground in a standard laboratory mill for around 2 minutes.

### Comparative Example 1

### One-Stage Heat Treatment

About 6275 g of un-heat-treated suspension of a melamine intercalation compound of the azobarbituric acid-nickel complex, prepared according to Preparation Example 1 and having a pigment content of 9.4%, corresponding to 591 g on a dry basis, are diluted with distilled water to a pigment content of 7.5%, for example. The diluted suspension is then adjusted directly to a pH of 1.5 using hydrochloric acid, and a temperature of 98° C. is maintained for 12 h. Thereafter the suspension is cooled to 95° C. and isolated by adjustment of the pH to 5.0 using potassium hydroxide solution.

The product is subsequently isolated on a suction filter, washed free of electrolyte, dried in a vacuum drying oven at 80° C. and ground in a standard laboratory mill for around 2 minutes.

### Inventive Example 1 and Following Examples

About 6275 g of un-heat-treated suspension of a melamine intercalation compound of the azobarbituric acid-nickel complex, prepared according to Preparation Example 1 and having a pigment content of 9.4%, corresponding to 591 g on a dry basis, are diluted with distilled water to a pigment content of 7.5%, for example. The pH is then adjusted to 3 using hydrochloric acid, and a temperature of 98° C. is maintained for 30 minutes. The pH is then adjusted to 1.5 and the temperature is held for 11.5 h. Thereafter the suspension is cooled to 95° C. and isolated by adjustment of the pH to 5.0 using potassium hydroxide solution.

The product is subsequently isolated on a suction filter, washed free of electrolyte, dried in a vacuum drying oven at 80° C. and ground in a standard laboratory mill for around 2 minutes.

With Comparative Example 1 and the Inventive Examples, and with the heat-treatment conditions listed in Table 1, the properties cited therein were obtained.

4 g of each test pigment were ground with 396 g of a commercial white paste, such as Ready Nova 70 from Nordsjö (Akzo Nobel), and 400 ml of glass beads with a diameter of 2 mm in a SüBmeier bead mill with cooling for 30 minutes. The pastes were applied to knife-coating paper using a spiral coating knife (25 μm) and subjected to colorimetry using the Gardner Color Guide 450 colorimeter.

The principle of colorimetry is described for example in Bayer Farben Revue, Special Edition 3/2 D, Farbmessung 1986.

The blank test (Comparative Example 1) has by definition a colour strength of 100%.

Preference is given to a colour strength which is as high as possible, and in particular a very high colour strength in tandem with comparatively low BET.

The ratio colour strengthᵢₙᵥₑₙₜᵢᵥₑ/colour strength_{blank test} ratio is preferably >1, in particular >1.05, with very particular preference >1.1.

Colour strength_{blank test}here denotes the colour strength of the metal compounds and/or host-guest compounds thereof which have been subjected to not more than one heat-treatment step.

TABLE 1
Heat treatment

| | | | | Tem- | | | |
|---|---|---|---|---|---|---|---|
| | | | | per- | | | |
| Inventive/ | Temper- | | | ature | pH | | |
| Comparative | ature I | pH | Time | II | Stage | Time | Colour |
| Example | (° C.) | Stage I | (h) | (° C.) | II | (h) | strength |
| 1* | 98 | — | — | 98 | 1.5 | 12 | 100 |
| 1 | 98 | 3 | 0.5 | 98 | 1.5 | 11.5 | 105 |
| 2 | 98 | 3 | 1 | 98 | 1.5 | 11 | 107 |
| 3 | 98 | 3 | 2 | 98 | 1.5 | 10 | 110 |
| 4 | 98 | 3 | 4 | 98 | 1.5 | 8 | 111 |
| 5 | 98 | 3 | 6 | 103 | 1.5 | 6 | 112 |

*Comparative Example 1

### Comparative Example 2

### One-Stage Heat Treatment

a) A 20 m³ reactor with jacket heating/cooling system, stirrer, flow disruptor and pumped circulation system is charged with 6000 litres of water at 80° C. with a stirring speed of 20 rpm. 380 kg of water-moist paste of diazobarbituric acid with a dry-matter content of 81%, corresponding to 308 kg dry, are introduced.

The temperature is maintained at 80° C. and at this temperature 268 kg of barbituric acid are introduced. Operation takes place with a pumped circulation, which is set at 15 m³/h. After 1 hour of pumped circulation the pH is adjusted over the course of 30 minutes to 5.0 using 30% strength potassium hydroxide solution, the potassium hydroxide solution being metered into the pumped circulation. This is followed by stirring at 80° C. and a pH of 5.0 for 2 hours, with pumped circulation. The batch is subsequently diluted with water to 15 000 litres. Subsequently it is heated to 90° C. and at this temperature 500 kg of melamine are introduced. The pumped circulation is set at 30 m³/h. Thereafter 1150 kg of 22.5% strength nickel chloride solution are metered in via the pumped circuit over the course of 30 minutes. 90 minutes of stirring follow, with pumped circulation, in order to achieve as a complete a reaction as possible. The pH is then adjusted to 5.0 over the course of 30 minutes, using 30% strength potassium hydroxide solution, the potassium hydroxide solution being metered into the pumped circulation.

b) In the non-inventive, one-stage heat treatment process 125 kg of 30% strength hydrochloric acid are added to this suspension directly as a fixed amount (in one portion) and a temperature of 98° C. is maintained for 12 hours. Thereafter the pH is adjusted to 5.0 over the course of 30 minutes using 30% strength potassium hydroxide solution, the potassium hydroxide solution being metered into the pumped circuit and the temperature being regulated to 80° C.

The reactor, which is free from baked-on deposits, can be very easily discharged virtually to completion. The homogeneous pigment slurry is isolated on a filter press, washed free of electrolyte and dried at 80° C.

### Inventive Example 6

In the first heat-treatment stage a pH of 3.0 is set over the course of 30 minutes in the suspension obtained according to a) of Comparative Example 2 at 90° C. via metering of approximately 50 kg of 30% strength hydrochloric acid into the pumped circuit. In the second heat-treatment stage 75 kg of 30% strength hydrochloric acid are added directly as a fixed amount and a temperature of 98° C. is maintained for 11.5 hours. The pH is subsequently adjusted to 5.0 over the course of 30 minutes using 30% strength potassium hydroxide solution, the potassium hydroxide solution being metered into the pumped circuit and the temperature being regulated at 80° C.

The reactor, which is free from baked-on deposits, can be very easily discharged virtually to completion. The homogeneous pigment slurry is isolated on a filter press, washed free of electrolyte and dried at 80° C.

### Inventive Example 7

In the first heat-treatment stage a pH of 3.0 is set over the course of 30 minutes in the suspension obtained according to a) of Comparative Example 2 at 90° C. via metering of approximately 50 kg of 30% strength hydrochloric acid into the pumped circuit and this is followed by 30 minutes of subsequent stirring. In the second heat-treatment stage 75 kg of 30% strength hydrochloric acid are added directly as a fixed amount and a temperature of 98° C. is maintained for 11 hours. The pH is subsequently adjusted to 5.0 over the course of 30 minutes using 30% strength potassium hydroxide solution, the potassium hydroxide solution being metered into the pumped circuit and the temperature being regulated at 80° C.

The reactor, which is free from baked-on deposits, can be very easily discharged virtually to completion. The homogeneous pigment slurry is isolated on a filter press, washed free of electrolyte and dried at 80° C.

### Inventive Example 8

In the first heat-treatment stage a pH of 3.0 is set over the course of 30 minutes in the suspension obtained according to a) of Comparative Example 2 at 90° C. via metering of approximately 50 kg of 30% strength hydrochloric acid into the pumped circuit and this is followed by 30 minutes of subsequent stirring. In the second heat-treatment stage 80 kg of potassium hydrogen sulphate are added directly and a temperature of 98° C. is maintained for 11 hours. The pH is subsequently adjusted to 5.0 over the course of 30 minutes using 30% strength potassium hydroxide solution, the potassium hydroxide solution being metered into the pumped circuit and the temperature being regulated at 80° C.

The reactor, which is free from baked-on deposits, can be very easily discharged virtually to completion. The homogeneous pigment slurry is isolated on a filter press, washed free of electrolyte and dried at 80° C.

The samples from Comparative Example 2 and from Inventive Examples 6, 7 and 8 were each ground in a standard laboratory mill for around 2 minutes and then subjected to the following tests.

4 g of each test pigment were ground with 396 g of a commercial white paste, such as Ready Nova® 70 from Nordsjö (Akzo Nobel), and 400 ml of glass beads with a diameter of 2 mm in a SüBmeier bead mill with cooling for 30 minutes. The pastes were applied to knife-coating paper using a spiral coating knife (25 μm) and subjected to colorimetry using the Gardner Color Guide 450 calorimeter.

The principle of colorimetry is described for example in Bayer Farben Revue, Special Edition 3/2 D, Farbmessung 1986.

The blank test (Comparative Example 2) has by definition a colour strength of 100%.

| | |
|---|---|
| Comparative Example 2 | Colour strength: 100 |
| Inventive Example 6 | Colour strength: 105 |
| Inventive Example 7 | Colour strength: 108 |
| Inventive Example 8 | Colour strength: 106 |

1. A process for preparing metal compounds of an azo compound of the formula (I) 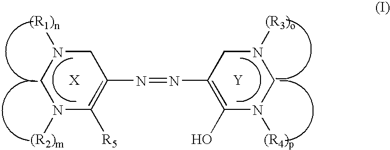
or tautomeric structures thereof,
in which
rings labelled X and Y may each carry one or two substituents from the series ═O, ═S, ═NR₇, —NR₆R₇, —OR₆, —SR₆, —COOR₆, —CN, —CONR₆R₇, —SO₂R₈, 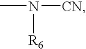
alkyl, cycloalkyl, aryl and aralkyl,
the sum of the endocyclic and exocyclic double bonds for each of rings X and Y being three,
in which
R₆ is hydrogen, alkyl, cycloalkyl, aryl or aralkyl,
R₇ is hydrogen, cyano, alkyl, cycloalkyl, aryl, aralkyl or acyl, and
R₈ is alkyl, cycloalkyl, aryl or aralkyl,
R₁, R₂, R₃ and R₄ are hydrogen, alkyl, cycloalkyl, aryl or aralkyl and additionally, as indicated in formula (I) by the interrupted lines, may form 5- or 6-membered rings, to which further rings may be fused,
R₅ is —OH, —NR₆R₇, alkyl, cycloalkyl, aryl or aralkyl,
in which R₆ and R₇ are as defined above,
and in the substituents given for R₁ to R₈ that contain CH groups the hydrogen atoms in the CH groups may be substituted,
and m, n, o and p may be 1 (one) or alternatively, where double bonds start from the ring nitrogen atoms on which the corresponding substituents R₁ to R₄ are located, as indicated in formula (I) by the dotted lines, may be 0 (zero),
and which optionally contain a guest compound,
wherein the metal compound or a host-guest compound thereof is heat-treated in at least two pH stages.

2. The process according to claim 1, wherein in the compound of the formula (I) the ring labelled X is a ring of the formula 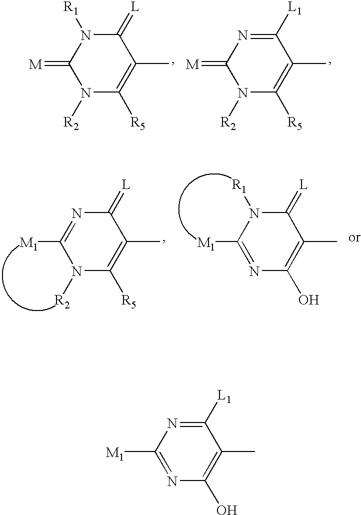
in which
L and M independently of one another are ═O, ═S or ═NR₆,
L₁ is hydrogen, —OR₆, —SR₆, —NR₆R₇, —COOR₆, —CONR₆R₇, —CN, alkyl, cycloalkyl, aryl or aralkyl, and
M₁ is —OR₆, —SR₆, —NR₆R₇, —COOR₆, —CONR₆R₇, —CN, —SO₂R₈, 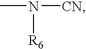
alkyl, cycloalkyl, aryl or aralkyl,
or the substituents M₁ and R₁ or M₁ and R₂ may form a 5- or 6-membered ring, and
R₁, R₂, R₅, R₆, R₇ and R₈ are as defined in claim 1.

3. The process according to claim 1, wherein the azo compound of the formula (I) conforms in the form of its free acid to the formula (II) or (III) or to a form tautomeric therewith 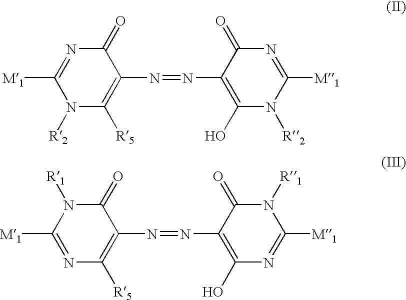
in which
R′₅ is —OH or —NH₂,
R′₁, R″₁, R′₂ and R″₂ are each hydrogen, and
M′₁and M″₁ independently of one another are hydrogen, —OH, —NH₂, —NHCN, arylamino or acylamino.

4. The process according to claim 1, wherein the azo compound of the formula (I) conforms in the form of its free acid to the formula (V) or to a form tautomeric therewith

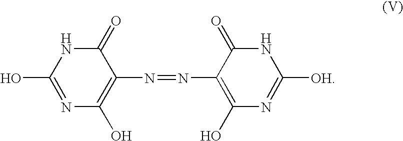

5. The process according to claim 1, wherein the metal compounds of the azo compound of the formula (I) are salts or complex compounds of the mono-, di-, tri- and tetraanions of the azo compound of the formula (I) with one or more metals selected from the group consisting of Li, Na, K, Mg, Ca, Sr, Ba, Al, Sn, Pb, Sc, Ti, V, Cr, Mn, Fe, Co, Ni, Cu, Zn, Y, Zr, Nb, Mo, Cd, Hf, Ta, W, La, Ce, Pr and Nd.

6. The process according to claim 1, wherein an Ni salt or an Ni complex of the azo compound of the formula (I) is used as metal compound.

7. The process for preparing metal compounds according to claim 1, wherein they contain as guest compound a cyclic or acyclic organic compound.

8. The process for preparing metal compounds according to claim 1, wherein they contain as guest compound melamine.

9. The Process for preparing metal compounds or the host-guest compounds thereof according to claim 1, wherein the heat-treatment stages are carried out in a dispersion having a solids content between 4%-15% by weight.

10. The process for preparing the metal compounds or the host-guest compounds thereof according to claim 1, wherein the heat-treatment stages are carried out at temperatures between 90° C. and 120° C.

11. The process for preparing the metal compounds or the host-guest compounds thereof according to claim 1, wherein the pH of at least one heat-treatment stage is between 2 and 4, and the pH of the second heat-treatment stage is between 0 and 3.

12. The process for preparing the metal compounds or the host-guest compounds thereof according to claim 1, wherein the pH of at least one heat-treatment stage is between 2 and 4, and the pH of the second heat-treatment stage is between 0 and 3, and the pH levels of these two heat-treatment stages differ by 0.5 to 3 units.

13. The process for preparing the metal compounds or the host-guest compounds thereof according to claim 1, wherein at least one, heat-treatment stage(s) last(s) between 0.25 h and 24 h.

14. The process for preparing the metal compounds or the host-guest compounds thereof according to claim 1, wherein the pigment is adjusted to a BET specific surface area of between 60 and 180 m²/g.

15. The process for preparing the metal compounds according to claim 1 or the host-guest compounds thereof, wherein the metal compounds or the host-guest compounds thereof that are prepared by the process according to claims 1 are spray-dried in the form of an aqueous slurry.

16. A process for producing colour filters in liquid-crystal displays, comprising the use of the metal compounds prepared by a process according to claim 1 or the host-guest compounds thereof.

17. A process for preparing pigment formulations, in which at least one metal compound or a host-guest compound thereof, prepared by a process according to claim 1 and at least one dispersant are mixed.

18. A process of colouring substrates with a pigment the pigment which is a metal compounds prepared by process according to claim 1 or of host-guest compounds thereof, or of the pigment formulations prepared according to claim 17.

19. A process for preparing printing inks, distempers or binder colours, for the mass colouring of synthetic, semisynthetic or natural macromolecular substances, and also for the spin dyeing of natural, regenerated or artificial fibres, and also for printing textiles and paper wherein a metal compound prepared by the process according to claim 1 or of host-guest compounds thereof, or of the pigment formulations prepared according to claim 17.

20. A process for colouring laminates, colour filters in liquid-crystal displays, or substances by an ink-jet printing with a pigment, the pigment is a metal compounds prepared by process according to claim 1 or of host-guest compounds thereof, or of the pigment formulations prepared according to claim 19.
